(19) United States
(12) Patent Application Publication
(10) Pub. No.: US 2004/0107968 A1
(43) Pub. Date: Jun. 10, 2004

(54) Oxygen mask with flexible face seal

(76) Inventor: Joseph Anthony Griffiths, Hazlemere (GB)

Correspondence Address: John N. Anastasi, Lowrie, Lando & Anastasi, LLP, One Main Street, Cambridge, MA, 02142, US

(21) Appl. No.: 10/639,393

(22) Filed: Aug. 12, 2003

(30) Foreign Application Priority Data
Aug. 12, 2002 (GB) 0218705.2

(51) Int. Cl. A62B 18/02; A62B 18/08

(52) U.S. Cl. 128/206.21; 128/206.26; 128/206.28

(57) ABSTRACT

An oro-nasal mask primarily for aircrew comprising a body shaped to fit around and enclose a wearer's nose and mouth. The mask has sealing means around the periphery thereof to make a seal with the wearer's face when fitted thereto, the sealing means comprising a resilient member provided around the periphery of the body which, in use, locates the mask on the wearer's face so that it makes a seal therewith and a flexible sealing membrane overlying said resilient member and operable independently thereof to reinforce said seal when pressurised breathable gas is supplied to the interior of the mask.

This patent application claims priority under 35 U.S.C. § 119(a) to United Kingdom patent application no. 0218705.2, filed Aug. 12, 2002.

### BACKGROUND

1. Field of Invention

This invention relates to an oxygen mask primarily intended for attachment to the flying helmet of aircrew but it can also have medical applications.

2. Related Art

Breathing equipment for aircrew normally comprises a flexible oro-nasal facemask having an inspiratory valve supplied with oxygen or some other breathable gas and an expiratory valve to allow the wearer to expel the air from the mask on exhalation. The facemask is attached to the wearer's flying helmet by means of a harness incorporating a releasable fitting.

In fighter aircraft, it is essential that the facemask makes a proper seal with the wearer's face at all times. Under normal flying conditions, this is not a problem as the wearer adjusts the harness tension so that the mask makes the necessary seal with his face and is also comfortable to wear. The supply of the breathable mixture through the mask is controlled by a breathing gas regulator which is responsive to the G-forces that it is subjected to. In other words, when the G-force increases, the pressure of the gas supply to the mask is correspondingly increased and vice-versa. Thus, changes in the G-forces applied to the regulator controlling the breathable gas supply result in automatic changes in pressure in the interior of the mask. It will be appreciated that unless some suitable means is provided to maintain the seal between the mask and the wearer's face, any substantial increase in pressure within the mask cavity can cause the mask seal to leak so that the wearer will not receive the pressure of breathable gas he requires and could black out.

One known way of overcoming this problem has been to include an over-centre toggle in the harness assembly attaching the mask to the pilot's helmet. This toggle is in a low-tensioned position for normal flight but, when the wearer wants to make a tight turn, he moves the toggle into its high tensioned position before he makes the turn which causes the facemask to be drawn more tightly against his face thereby hopefully improving its seal therewith. After the turn is completed, he then releases the toggle. Indeed, he has to do this because the pressure exerted by the mask on his face when the toggle is engaged is so great that it is very uncomfortable to wear. The main problem with this arrangement is that the wearer must remember to engage the toggle before he makes a turn (possibly difficult in a combat situation) and release it after the turn has been completed because the pressure on his face is too high to be comfortable for normal flying.

In order to overcome these problems, the facemask disclosed in European Patent No. 0541569 was developed and a breathing apparatus was provided in which the oro-nasal mask was mounted in a rigid shell attached to the wearer's helmet at a fixed distance therefrom, the oro-nasal mask including extendable means operable to cause the oro-nasal mask or a portion thereof to move automatically relative to the wearer's face to vary the seal therewith dependent on the breathable gas pressure supplied to the mask.

In a first embodiment of this prior art mask, the extendable means is an inflatable bladder located between the oro-nasal mask and the rigid shell. In a second embodiment, the extendable means is located in the wall of the oro-nasal mask and comprises a series of folds or bellows. In both embodiments, when breathable gas at a pressure above that needed for normal breathing is supplied to the bladder or the interior of the oro-nasal mask, the bladder inflates or the bellows or folds extend to move the mask and/or seal thereon relative to the rigid shell in which it is mounted and thereby automatically vary the pressure of the mask on the wearer's face and its seal therewith dependent on the pressure of the breathable gas supplied to it. The essence of this solution is that the position of the rigid shell in which the dynamically movable oro-nasal mask is mounted is held and maintained at a fixed distance from the wearer's face and helmet so that the mask and seal can be made to move relative to this fixed shell and therefore relative to the wearer's face.

This solution provided a substantial improvement over the prior art systems because it automatically positioned and sealed the oro-nasal facemask onto the wearer's face as the G-forces generated during the turn increased, the pressure on the wearer's face reducing automatically as the turn was completed and the G-forces reduced.

Modern fighter aircraft can now generate up to 9G in a turn so the pressure of breathable gas supplied to the interior of the mask has to be substantially increased if he is to be able to breath satisfactorily and not lose consciousness and black out during the turn due to a lack of oxygen supplied to the brain. Thus, any breathing system that he uses must ensure that the periphery of the oro-nasal mask makes and maintains a seal with his face at all times otherwise the breathable gas at high pressure supplied to the interior of the mask will leak out at its edge seal and he will not receive the required amount of high pressure gas needed to keep him conscious.

### SUMMARY

It has been found therefore that the edge seal of the prior art systems referred to above tend to leak when they are subjected to high G-forces for a variety of reasons. For instance, the mask has to fit the wearer's face and each wearer has a different facial configuration particularly in the nose and cheek area on either side of the nose which is the area where it is most difficult to achieve the seal. It has been found that whilst the prior art reflex seals which usually comprise a flexible re-entrant skirt formed around the periphery of the aperture in the mask in which the wearer inserts his face, nose and mouth which are made of the same material as the rest of the mask work satisfactorily at low G-forces, they can leak at higher G-forces with fatal consequences.

It is an object of the invention therefore to provide an oro-nasal mask which can maintain its seal with the wearer's face when subject to G-forces up to 9G.

According to the invention, there is provided an oro-nasal mask comprising a body shaped to fit around and enclose a wearer's nose and mouth, the mask having sealing means around the periphery thereof to make a seal with the wearer's face when fitted thereto, wherein the sealing means comprises a resilient member provided around the periphery of the body which, in use, locates the mask on the wearer's face so that the mask makes a seal therewith and a flexible sealing membrane overlying said resilient member and operable independently thereof to reinforce said seal when pressurised breathable gas is supplied to the interior of the mask.

Preferably, the flexible membrane includes a skirt which lightly contacts the wearer's face.

In one embodiment, the body is moulded with an annular inwardly directed web around the periphery thereof to provide said resilient member which is pressed against the wearer's face around the wearer's nose and chin when the mask is fitted thereto, and the flexible membrane is attached to the resilient member at a location axially spaced away from the part of the resilient member which is pressed against the wearer's face.

Preferably, the resilient member is curved in cross section with a rolled tapered peripheral edge and the flexible membrane is secured to the resilient member.

The body and flexible membrane can be moulded from a natural or synthetic rubber material. The body can however be a separate rigid member with the sealing means attached thereto.

The flexible membrane is preferably shaped so that when a pressurised breathable gas is supplied to the interior of the mask when said mask is fitted to a wearer's face, the membrane is pressed into sealing engagement with the wearer's face to improve and reinforce the seal therewith as the pressure of the breathable gas increases.

In the preferred embodiment, the portion of the flexible membrane extending over the portion of the resilient member which is pressed against the wearer's face and the peripheral edge region of the flexible membrane are both pressed into contact with the wearer's face when a pressurised gas is supplied to the interior of the mask.

The body may be made of a rigid or resilient material.

The body and the resilient member can be moulded from the same material.

It will be seen from the foregoing that the invention provides a mask which, in use, is capable of receiving a high pressure breathable gas (e.g., up to 70 mm of mercury) while still maintaining an effective and comfortable seal with the wearer's face.

A preferred embodiment of the invention will now be described, by way of example only, with reference to the accompanying drawings, in which:

### BRIEF DESCRIPTION OF THE DRAWINGS

FIG. 1 shows a prior art oxygen mask and helmet mounting system;

FIG. 2A is a perspective view of the prior art oxygen mask shown in FIG. 1;

FIG. 2B is a schematic plan view of the prior art oxygen mask shown in FIG. 1 when in its initial position on a wearer's face (shown by the dotted lines), its distorted configuration when highly pressurised gas is supplied to the interior of the mask being shown in full line;

FIG. 3A is a side view of a first embodiment of oxygen mask of the invention having a flexible sealing skirt;

FIG. 3B is a perspective view of the mask shown in FIG. 3A with part of the flexible sealing skirt cut away;

FIG. 3C shows the areas how the flexible skirt of the mask of FIG. 3B is secured to the mask body;

FIG. 3D is a schematic plan view of the oxygen mask shown in FIGS. 3A-3C when in position on a wearer's face both when initially fitted and also when subjected to high internal gas pressure (shown by the dotted lines);

FIG. 4A is a side view of a second embodiment of oxygen mask of the invention having a flexible sealing skirt;

FIG. 4B is a perspective view of the mask shown in FIG. 4A with part of the flexible sealing skirt cut away; and

FIG. 4C is a schematic plan view of the oxygen mask shown in FIGS. 4A and 4B when in position on the wearer's face.

### DETAILED DESCRIPTION

Referring now to the drawings, FIG. 1 shows a wearer 1 wearing a rigid protective helmet 2. A flexible oro-nasal mask 4, usually made of a natural or synthetic rubber material, surrounds the wearer's nose and mouth and is mounted in a rigid plastics shell 3. The shell 3 and oro-nasal mask 4 are attached to the helmet 2 by means of harness assembly which can be a pair of fabric straps or the illustrated pair of solid wires 10 connected to an over-centre toggle 8 pivotally mounted at 9 on the front of the rigid shell 3. Each wire 10 includes known adjustment means 13 and its end remote from the rigid shell 3 is releasably fitted in a respective mounting 12 of known type on either side of the helmet 2. The adjustors 13 allow the length of the wire 10 to be readily altered by the wearer to ensure that the facemask 4 rests comfortably on his face with its sealing section 4A making a seal with the area of the wearer's face surrounding his nose and mouth.

From the foregoing, it can be seen that the oro-nasal mask 4 is held against the wearer's face by means of the wires 10 attached to the toggle 8. As illustrated, the toggle is in its normal “up” position which holds the oro-nasal mask 4 in normal sealing engagement with the wearer's face. However, when the toggle 8 is pivoted in the direction of arrow A downwardly about the pivot 9, the mask 4 is moved in the direction of the arrow B into tighter engagement with the wearer's face for reasons which will be explained hereafter.

Breathable gas such as oxygen is supplied to the interior of the facemask 4 through inlet hose 5. The pressure of the gas supplied is controlled by a regulator (not shown) of known type which is responsive to the G-forces it is subjected to to increase or decrease the pressure of the breathable gas. This is done automatically so if the wearer makes a turn which subjects the aircraft to an increase in G-force, the regulator will increase the pressure of the gas supplied to the wearer through the inlet hose 5 and oro-nasal mask 4 fitted to his face in known manner.

A microphone 6 of known type is mounted on the front of the rigid shell 3 in known manner and has a wire 7 having a plug (not shown) at its other end which can be connected to the communications system of the aircraft which the wearer is flying.

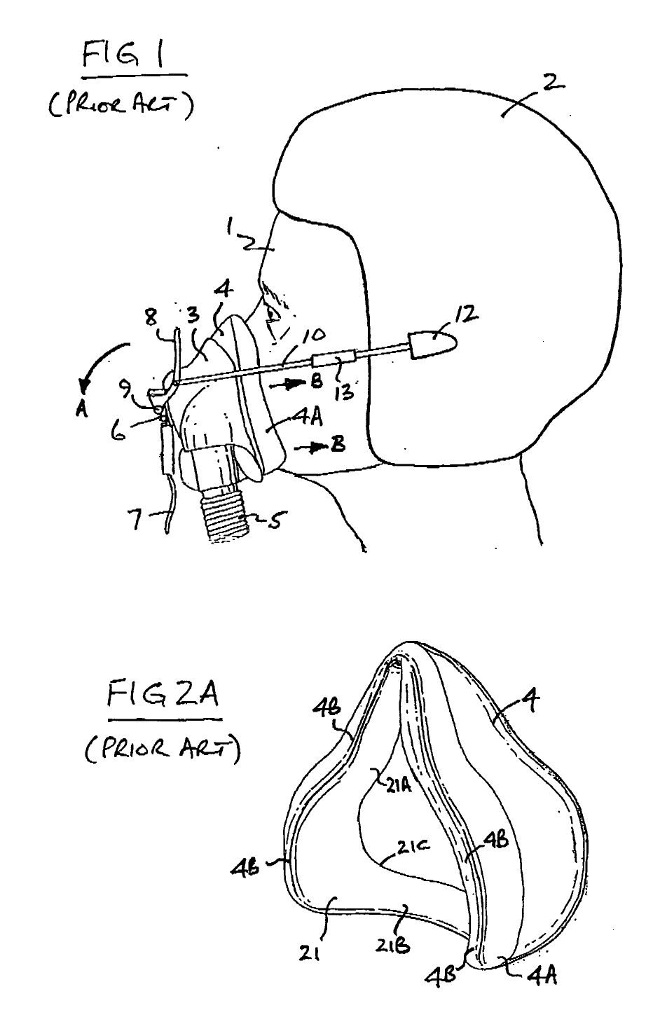

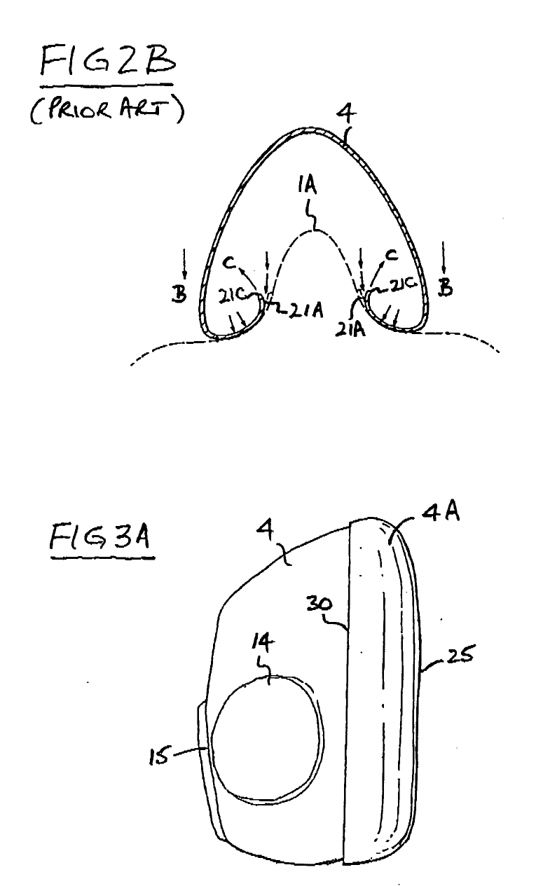

FIG. 2A shows the oro-nasal mask of FIG. 1 in more detail and it can be seen that the sealing portion 4A has an inwardly directed re-entrant web 21 which is shaped to contact the wearer's face and make a seal therewith in the area on either side of his nose and also against his chin. Upper web portions 21A (only one is visible) contact his face in the nose and cheek areas whereas bottom portion 21B engages his chin area. The web 21 is annular and has an inner edge 21C.

FIG. 2B shows the way in which the web 21 attempts to seal against the wearer's face. In normal flying conditions when the toggle 8 (see FIG. 1) is in its “up” position, the nose region 21A of the web 21 tries to contact and seal against the wearer's nose 1A as illustrated by the dotted line. However, when the wearer knows he is going to have to make a turn generating high G-forces, he pulls the toggle 8 downwardly in the direction of arrow A thereby forcing the oro-nasal mask 4 to move in the direction of arrow B into tighter engagement with his face. This causes the edge 21C of the web 21 on either side of his nose to splay outwardly away from the wearer's nose 1A in the direction of the arrows C. The gas regulator (not shown) is now supplying breathable gas at a much higher pressure to the interior of the mask 4 which gets under the upturned edge 21C of each flange 21A and thus forces it further away from the wearer's nose 1A thereby causing the seal to leak in the region on either side of his nose. This leakage means that he is not being supplied breathable gas at the required pressure to prevent him blacking out and the consequences can be serious.

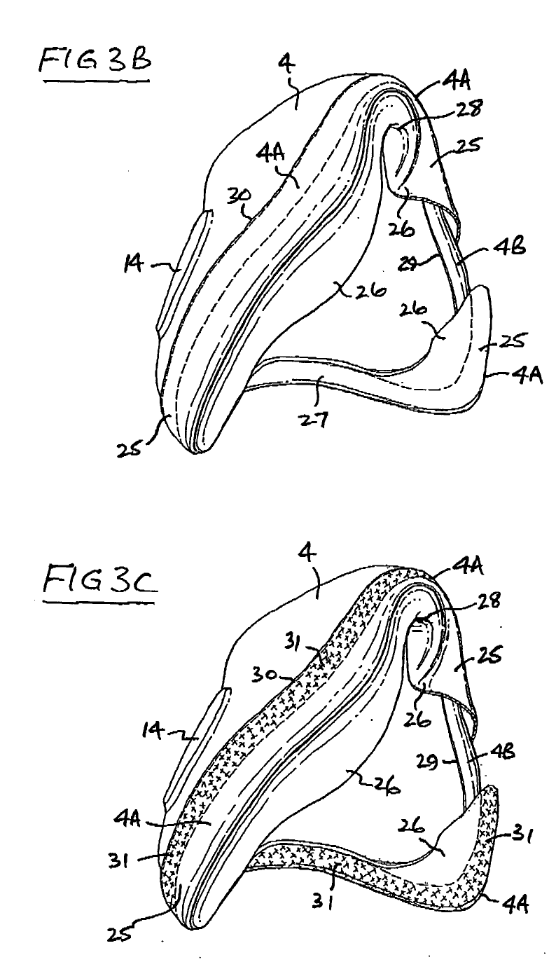

Referring now to FIGS. 3A-3D, there is shown an improved oro-nasal mask of the present invention which is capable of maintaining a seal with the wearer's face even when very high breathable gas pressures are generated inside the mask as he is subjected to very high G-forces. As can be seen from the drawings, the mask 4 differs from the one-piece prior art mask shown in FIGS. 1 and 2 in that it is formed in two parts, namely a semi-rigid front body portion 4 to which a separate flexible sealing section 4A is attached to make the seal with the wearer's face. The relationship between the flexible sealing section 4A and the body section 4 is better illustrated in the perspective views of the mask shown in FIGS. 3B and 3C.

Section 4 of the body is manufactured from a natural or synthetic rubber material which is flexible but reasonably rigid. The sealing section 4A on the other hand is manufactured from a much thinner more flexible natural or synthetic rubber material for reasons which will be explained hereafter. The flexible section 4A comprises a flexible membrane 25 of a similar shape to the open end of the body 4 to which it is to be fitted and as illustrated in the drawings. The membrane 25 has an inwardly directed annular skirt 26 adapted to contact the wearer's face on either side of his nose and a bottom section 27 which contacts his chin area. The membrane 25 is secured to the body 4 along line 31 illustrated in FIG. 3C by the cross latched areas. Although the skirt 26 is shown as being attached to the bottom of the mask 4 in the chin area over the whole area thereof this is not essential.

A feature of the mask of the invention is that the body 4 includes a resilient member which is curved in cross section to provide a rolled edge 4B around its entire periphery (see FIGS. 3C and 3D). This rolled edge 4B is important in locating the mask on the wearer's face and furthermore, it provides mechanical strength for the body 4 to enable it to contact the wearer's face without distorting the skirt 26 so a seal with the wearer's face is achieved.

FIG. 3D shows the mask 4 in position on the wearer's face and it can be seen that the web 26 lies against the wearer's face including the nose 1A.

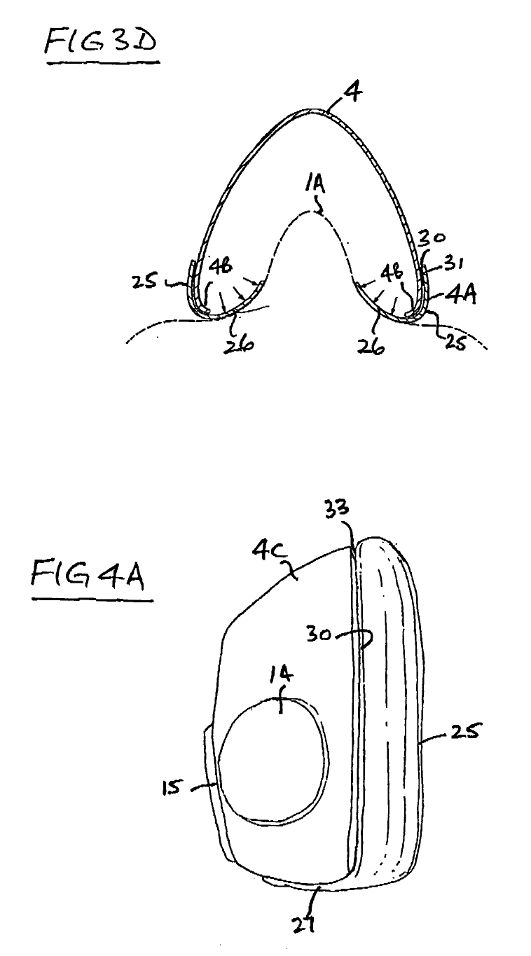

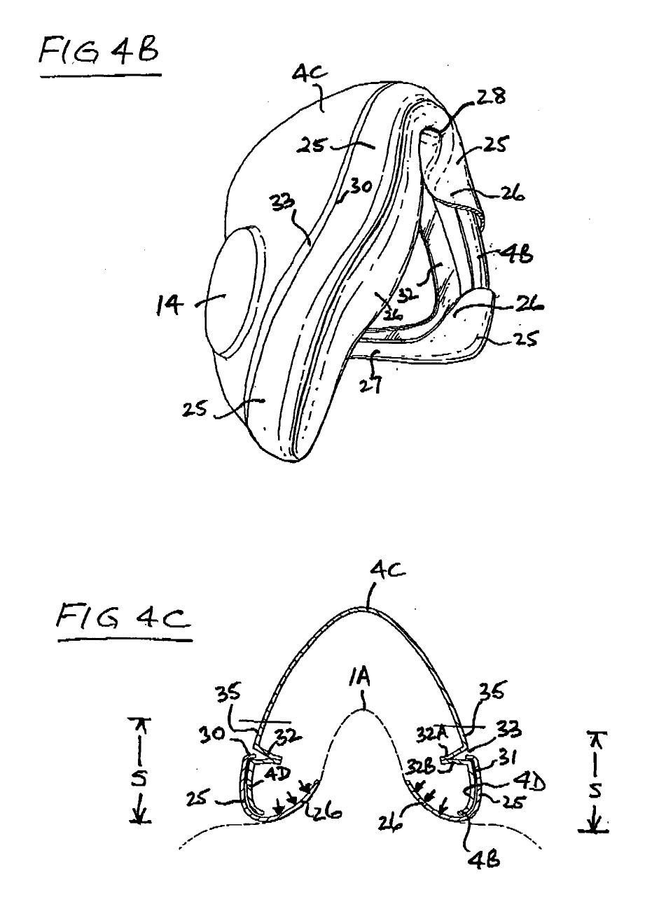

An alternative facemask of the invention is shown in FIGS. 4A-4C which is very similar to that shown in FIGS. 3A-3C except that the body 4 comprises front portion 4C and rear portion 4D. Extendable means in the form of re-entrant section 32 (see FIG. 4C) are provided in the wall of the body 4 around the periphery thereof and is formed by an inwardly directed flange 32A on front portion 4C which is secured to a similar inwardly directed annular flange 32B on rear portion 4D which terminates in rolled edge 4B. The flexible sealing membrane 25 is affixed to the rear body portion 4D at 31. As with the embodiment shown in FIGS. 3A-3C, the membrane 25 is attached to the rear body section 4D closely adjacent the re-entrant section 32. As illustrated, the chin region 27 of the membrane 25 is attached to the re-entrant section 32 immediately behind it across the whole surface thereof to give it extra rigidity and improve its seal with the wearer's face but this is not essential. Otherwise, the construction of the mask shown in FIGS. 4A-4B is identical to that shown in FIGS. 3A-3C.

The way in which the two masks of the invention work is better illustrated in FIGS. 3D and 4C. First of all, the wearer fits mask 4 housed in the rigid shell 3 against his face and attaches the wire 10 on either side thereof to the respective mountings 12 on his helmet 2. He then rotates the adjustors 13 so that the mask is comfortably held against his face and makes a general seal therewith. In this position, the rolled edge 4B of the body portion of the mask 4 which is located underneath the flexible membrane 25 pushes it into contact with his face and a seal is achieved therewith by means of the skirts 26 on either side of his nose and the chin skirt 27. As the rolled edge 4B is annular, this seal will extend around his nose and mouth and the web portions 26 of the membrane 25 resting against the wearer's nose and cheek areas adopt the configuration shown in FIG. 3D. Because the web portions 26 extend generally inwardly from the edge of the skirt at 90° thereto and they are flexible, when the mask is fitted to the wearer's face, the web portions 26 adopt their positions shown in FIG. 3D and lie closely against the wearer's nose or cheek areas. Similarly, the bottom chin region 27 rests against his chin. When breathable gas under pressure is supplied to the interior of the mask 4, the gas will apply pressure to the web portion 26 lying against the wearer's face in the direction of the arrows so they operate independently of the seal already created and press the web portion 26 into better engagement with the pilot's face thereby improving and reinforcing the seal therewith. It should be noted that there is a space between the body 4 and the membrane 25 in this region as the membrane 25 is not attached to it over its whole width. As a result, the membrane 25 in this region will inflate slightly due to the gas pressure which further improves the seal with the wearer's face in the region of the annular rolled edge 4B.

The mask shown in FIGS. 4A-4C operates in the following manner. The mask 4 is mounted in a rigid shell 3 in the same way as is shown in the prior art mask of FIG. 1. However, the wires 10 are attached directly to the front of the rigid shell 3, their other ends being received in respective mountings 12 on either side of the helmet 2. Thus, when the rigid shell 3 housing the flexible mask 4 is fitted onto the wearer's face and it is attached to the helmet 2 by means of the wires 10, the rigid shell 3 is mounted at a fixed distance from the helmet 2. Accordingly, when breathable gas is supplied to the interior of the mask 4 through the hose 5, the mask has to expand but it cannot move forwardly because it is constrained within the rigid shell 3. It can therefore only move in a direction towards the wearer's face thereby increasing the seal therewith as described in our European patent No. 0541549. As the gas pressure supplied to the interior of the mask 4 increases or decreases, so the re-entrant section 32 (see FIG. 4C) can extend or contract thereby allowing the section 4C of the mask 4 to move towards or away from the wearer's face automatically in response to the gas pressure.

The mask shown in FIGS. 4A-4C also operates in the same way as that described with reference to FIGS. 3A-3D in that when pressurised gas is supplied to the interior of the mask, the web portion 26 of the flexible membrane 25 tends to be pressed more firmly into contact with the wearer's nose thereby improving and reinforcing the seal therewith. At the same time, the seal in the region of the mask adjacent the rolled edge 4B increases as the pressurised gas gets into the space between the section 4D and the skirt 25 inflates it.

Although the sealing means on the mask shown in FIGS. 3A-3C is attached to the body 4 it could be moulded integrally therewith.

In the mask shown in FIGS. 4A-4C, the sealing means is shown attached to the rear portion 4D of the body adjacent the web 32. However, the front body portion 4C could be a separate rigid shell and the sealing means could be a separate section S (see FIG. 4C) and section 35 thereof would be glued or otherwise attached to the rigid shell.

For the avoidance of doubt, although the mask has been described herein in relation to its use by the pilot of an aircraft, it could also be used by other aircrew such as the navigator. The sealing principle of the mask of the invention can also be used in medical applications involving the use of a breathing mask which needs to make a facial seal with the patient at elevated pressures.

What is claimed is:

1. An oro-nasal mask comprising a body shaped to fit around and enclose a wearer's nose and mouth, the mask having sealing means around the periphery thereof to make a seal with the wearer's face when fitted thereto, wherein the sealing means comprises a resilient member provided around the periphery of the body which, in use, locates the mask on the wearer's face so that the mask makes a seal therewith and a flexible sealing membrane overlying said resilient member and operable independently thereof to reinforce said seal when pressurised breathable gas is supplied to an interior of the mask.

2. The mask as claimed in claim 1 wherein the flexible membrane includes a skirt which contacts the wearer's face.

3. The mask as claimed in claim 1 wherein the body is moulded with an annular inwardly directed web around the periphery thereof which provides said resilient member which is pressed against the wearer's face around the wearer's nose and chin when the mask is fitted thereto.

4. The mask as claimed in claim 1 wherein the flexible membrane is attached to the resilient member at a location axially spaced away from the part of the resilient member which is pressed against the wearer's face.

5. The mask as claimed in claim 1 wherein the resilient member is curved in cross section with a rolled tapered peripheral edge.

6. The mask as claimed in claim 1 wherein the flexible membrane is secured to the resilient member.

7. The mask as claimed in claim 1 wherein the body is moulded from a natural or synthetic rubber material.

8. The mask as claimed in claim 1 wherein the flexible membrane is moulded from a natural or synthetic rubber material.

9. The mask as claimed in claim 1 wherein the flexible membrane is shaped so that when a pressurised breathable gas is supplied to the interior of the mask when said mask is fitted to a wearer's face, the membrane can only be positioned into sealing engagement with the wearer's face to improve and reinforce the seal therewith as the pressure of the breathable gas increases.

10. The mask as claimed in claim 9 wherein the portion of the resilient member which is pressed against the wearer's face is located behind the flexible membrane.

11. The mask as claimed in claim 9 wherein the portion of the flexible membrane extending over the portion of the resilient member which is pressed against the wearer's face and the peripheral edge region of the flexible membrane are both pressed into contact with the wearer's face when a pressurised gas is supplied to the interior of the mask.

12. The mask as claimed in claim 1 wherein the body is made from a resilient material.

13. The mask as claimed in claim 12 wherein the body and the resilient member are moulded from a same material.

14. The mask as claimed in claim 1 wherein the body is a discrete member to which the sealing means is attached.

15. The mask as claimed in claim 14 wherein the body is made from a rigid material.

16. The mask as claimed in claim 1 which, in use, is capable of receiving a high pressure breathable gas while still maintaining an effective seal with the wearer's face.
